(19) United States
(12) Patent Application Publication
(10) Pub. No.: US 2013/0264941 A1
(43) Pub. Date: Oct. 10, 2013

(54) AUTOMOTIVE DEVICE CONTROLLING OPERATION OF OPTIONAL TAIL LIGHTS EQUIPMENT

(71) Applicant: Slava Osherov, Randolph, NJ (US)

(72) Inventor: Slava Osherov, Randolph, NJ (US)

(21) Appl. No.: 13/443,805

(22) Filed: Apr. 10, 2012

(51) Int. Cl. B60Q 1/30

(52) U.S. Cl. 315/77

(57) ABSTRACT

The present invention relates to an automotive device which will control the operation of optional tail lights equipment by monitoring level of current in any motor vehicle OEM tail lights electrical circuit. The device comprises a plurality of current sensor modules, each including a current sensor and a RF transmitter antenna, and a brain module including a controller, a RF receiver antenna, and a power source. The current sensors are placed on top of OEM tail lights wire to monitor the current level and transmit such information to brain module. When the level of current detected by any current sensor raises above certain level the controller closes electrical circuit of the optional tail light equipment dedicated to that particular Sensor; when the level of Current lowers under certain level, the controller opens the electrical circuit of the optional tail light equipment dedicated to that particular Sensor.

### BACKGROUND OF THE INVENTION

1. Field of the Invention

The present invention relates to a method and device for controlling the operation of optional tail lights equipment, and more particularly to a method and device that controls the operation of optional tail lights equipment by monitoring level of current in any motor vehicle OEM tail lights electrical circuit.

2. Description of Related Art

All existing methods of optional motor vehicle tail lights connectivity requires installation of sophisticated and expensive equipment which is in common designed only for a particular vehicle year, make and model. High end models of motor vehicles require installation of optional equipment performed by the dealer only, commonly followed by time consuming and costly re-programming.

In many occasions, motor vehicle owners are choosing inexpensive methods for optional tail lights connectivity via splitting the OEM wire harness. Such method damages protection layer of wire allowing moisture to penetrate inside, contributes to a failure of OEM tail lights operation, damages vehicle electronic equipment, creates fire hazard conditions.

The growing popularity of LED tail lights changes the design and main parameters of motor vehicle electrical circuit making, in some cases, making older optional light equipment unusable (for example traditional incandescent tail lights)

Accordingly, there is a need to have a device that can solve all or most of the foregoing problems.

One object of the present invention is to provide a device that is economical, easy to install and uninstall and does not damage OEM wiring harness. Another object of the present invention is to provide a device that is vehicles' year, make and model independent. A further object of the present invention is to provide a device that can control LED and/or incandescent optional tail lights equipment as well as work with LED and/or incandescent OEM tail lights equipment. Yet another object of the present invention is to provide a device that is sensitive to a wide range of automotive current and has flexible power source.

### SUMMARY OF THE INVENTION

In an exemplary embodiment of the present invention, there is disclosed an automotive device which will control the operation of optional tail lights equipment by monitoring the level of current in any motor vehicle OEM tail lights electrical circuit and a method of controlling the operation of optional tail lights equipment using said automotive device.

The automotive device according to the present invention comprises at least one Current Sensor module and a Brain Module. The Current Sensor module mounted on top of the OEM tail lights wire will constantly transmit encoded signal via wireless or hard wire to the Brain module with the level of current in the underneath wire. Based on the Current Sensor readings, the Brain module opens or closes corresponding electrical circuit of the optional tail lights equipment that is dedicated to that particular current sensor. The Brain module will utilize source of 12V power from motor vehicle standard cigarette lighter connector or from independent source of power built in the Brain module to supply power to the optional tail lights equipment.

Quick installation and un-installation of the device allows sharing of the device between multiple vehicles in the household. The device does not require alterations of motor vehicle body. The wrap around design of current sensor module eliminates necessity of damaging the wire harness. Its generic design makes it operable on any existing motor vehicle. The built in electronic solution will detect type of controlled lights and automatically adjust output characteristics. The device is designed to monitor wide range of current which makes it effective with any type of motor vehicle OEM tail light system. The device may utilize existing on-board 12V DC power or independent power source.

The invention can be widely used with any 12/24V DC motor vehicle, which requires additional stop, left/right turn or running lights equipment. For example: trailer tail lights, tow behind vehicle, motorcycle optional equipment which require installation of additional tail lights such as side luggage or top boxes, etc.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a schematic block diagram of four current sensor modules which is a component of the device according to an embodiment of the present invention.

FIG. 2 is a schematic block diagram of a brain module which is a component of the device according to an embodiment of the present invention; FIG. 2A is a brain module without independent power source; FIG. 2B is a brain module with an independent power source (e.g. a rechargeable battery).

FIG. 3 is a process flow diagram showing how the device controls the optional brake lights work when a brake pedal is pressed down and released using said device of FIG. 1 and FIG. 2.

FIG. 4 is a flow chart illustrating a method of controlling optional tail lights equipment using said device of FIG. 1 and FIG. 2.

### DESCRIPTION OF THE PREFERRED EMBODIMENT

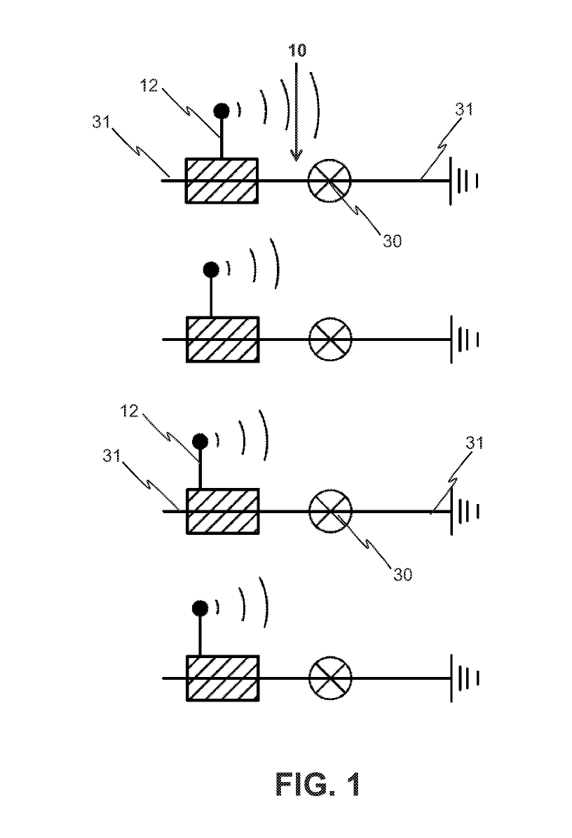

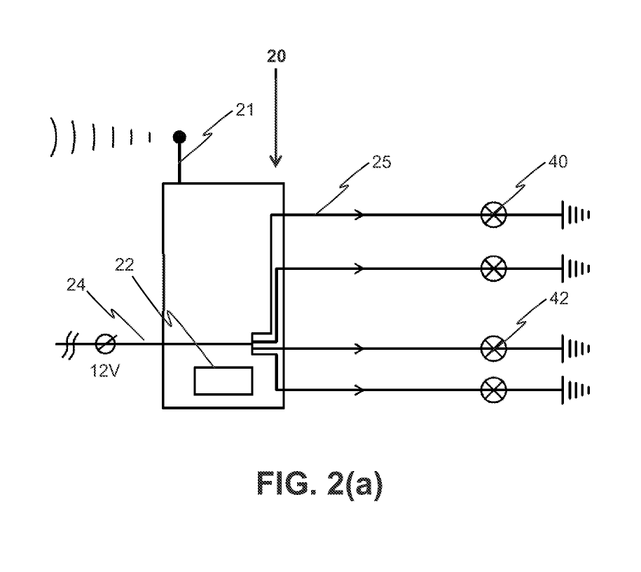

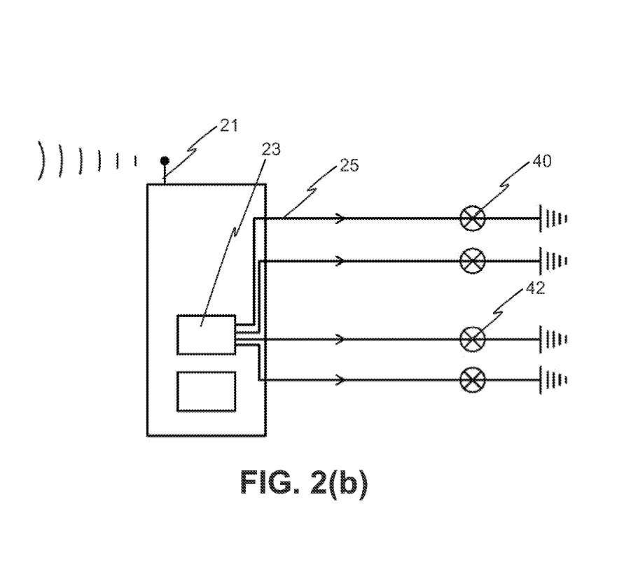

Referring to FIGS. 1 and 2, there is disclosed an optional tail lights controlling device according to one preferred embodiment of the present invention. In this preferred embodiment, the entire device 1 comprises four Current Sensor modules 10 and a Brain Module 20. Each current sensor module 10 comprises a current sensor 11, means for communicating through wireless and/or hard wired connection, and an independent built-in rechargeable source of power (not shown). A Current Sensor 11 is a device that detects electrical current (AC or DC) in a wire, and generates a signal proportional to it. Each of the four sensors 10 is mounted inside the motor vehicle on top of the OEM tail lights wire 31 including the right turn wire, left turn wire, running light wire, and stop (brake) light wire, respectively. Each sensor 10 must be paired off with the Brain Module 20 upon completion of installation. The current sensors are all interchangeable. When the device 1 gets relocated to another vehicle, the pair off procedure must be repeated. Brain module 20 can be re-set during pairing off process. The Current Sensor module 10 can send the monitored current signal to the Brain Module 20 through the existing attached hard wires (not shown). Each of four Current Sensor modules 10 may further comprise a RF transmitter antenna 12 for transmitting measured current signal to the Brain Module using any available automotive allocated bandwidth.

Brain Module 20 comprises means for communicating with the Current Sensor module 10, a controller 22 which may be one of a programmable integrated circuit, a microprocessor and/or programmable logics controller (PLC) for assigning a unique ID to each Current Sensor module and pairing off process, controlling (opening/closing) electrical circuit of the optional tail lights equipment, and means for supplying power to the optional tail lights equipment. Brain Module 20 may be hard wired to Current Sensor assembly 10 using existing attached wires for receiving signals from the Current Sensor assembly 10. Alternatively or simultaneously, Brain Module may comprise a radio frequency (RF) receiver antenna 21 for receiving signals from the Current Sensor assembly 10 by wireless using any available automotive allocated bandwidth.

There are two available power sources of Brain Module 20 for supplying power to the optional tail lights equipment. In one embodiment, Brain Module does not have power supply source; it may be equipped with hard wires (cables) 24 on one end to plug in a motor vehicle on-board 12V DC power and with hard wires 25 on the other end to connect with the remotely located optional tail lights equipment 40. With this design, Brain Module 20 extends on-board 12V DC power to remotely located optional tail lights equipment. In another embodiment, Brain Module 40 may contain its own independent source of 12V DC power including but not limited to a rechargeable battery 23. With this design, Brain module can be located inside or outside of the motor vehicle. The Brain module is hard wired 25 to the remotely located optional tail lights equipment 40 and supplies power to said lights using its own battery 23. The rechargeable battery 23 within the Brain module 20 may be charged using the standard four pin connector to connect to the on-board motor vehicle power during parking period or in operational mode. The solar device can be used to charge the rechargeable battery 23 of Brain Module 20.

The controller being one of a programmable integrated circuit, microprocessor or programmable logics controller (PLC) in the Brain

Module controls the operation of the electrical circuit 25 supplying power to the optional tail light equipment 40. Current Sensor modules 10 are all interchangeable. Each of the current sensor modules 10 requires a pairing off process to receive a unique ID that is dedicated to a particular optional tail light equipment 40. The microprocessor or PLC is in charge of ID assignment and has memory to store the ID corresponding to each Current Sensor module 10 and its dedicated optional tail light equipment 40. A Current level is predetermined in the controller 22 as a threshold to determine and control the opening/closing of the circuit 25 that supplies power to each of optional tail light equipment 40. A mechanism for closing and opening the electrical circuit 25 of optional tail lights equipment 40 is not discussed as this is well known to those with ordinary skill in the art of electrical circuitry.

After each sensor 10 is paired off with the Brain Module 20, Brain Module 20 constantly receives signals (information) from each of the installed Current Sensors 10. When level of Current raises above certain level, Brain Module 20 closes electrical circuit 25 of the optional tail light equipment 40 dedicated to that particular Sensor 10. The reverse process is happening when level of Current lowers under certain level. In this case Brain Module 20 opens the electrical circuit 25 of the optional tail light equipment 40 dedicated to that particular Sensor 10.

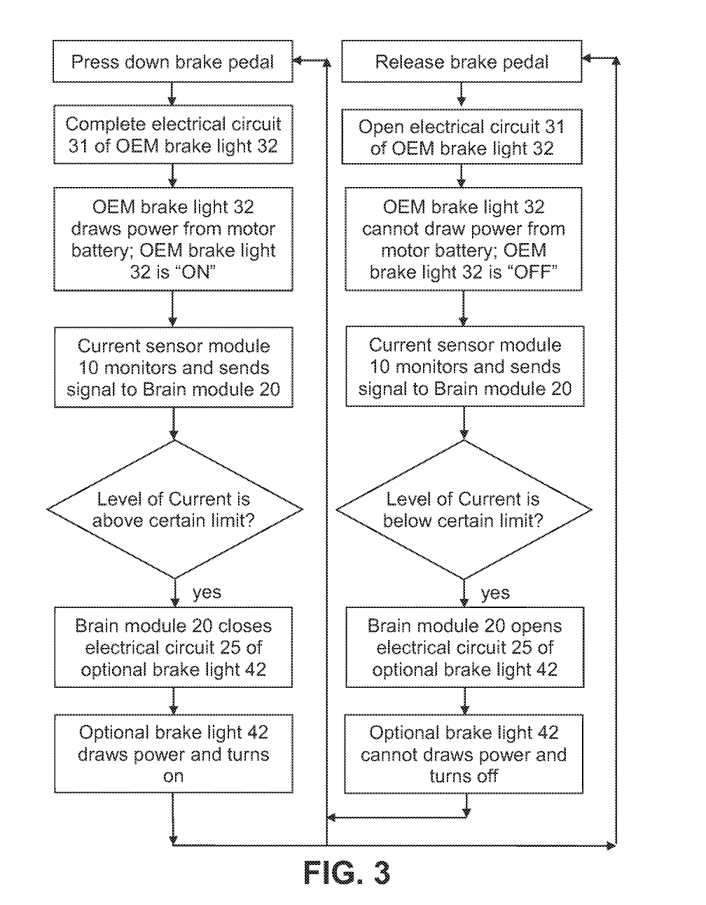

As illustrated in FIG. 3 using a brake (or stop) light as an example, when a brake pedal is pressed down and makes contact with the OEM brake switch, it completes the electrical circuit 31 of the OEM brake light 32; the OEM brake light 32 draws power from the motor vehicle battery, the current level in the wire is raised. Simultaneously, the Current Sensor 10 that is mounted on top of the brake light wire 31 constantly monitors the electrical current in said wire 31 and generates and transmits a signal proportional to the electrical current to the Brain Module 20. When the Brain Module 20 receives the signal showing the electrical current is above the predetermined threshold, Brain Module 20 closes the electrical circuit 25 of the optional brake light 42, the optional brake light 42 then draws power from the battery 23 within Brain Module 20 or from the motor vehicle on-board 12V DC power through wire 24 and Brain Module 20. Consequently, the optional brake light 42 is turned “on”. On the contrary, when the brake pedal is released, the OEM brake switch is not in contact so that the electrical circuit 31 of the OEM brake light is open. There is no or little current flow in the OEM brake light 32 wire 31 that will be detected by the current sensor 10. Therefore, the Brain module opens the electric circuit 25 of the optional brake light 42 and no power can be drawn by the optional brake light 42 when is then “Off”.

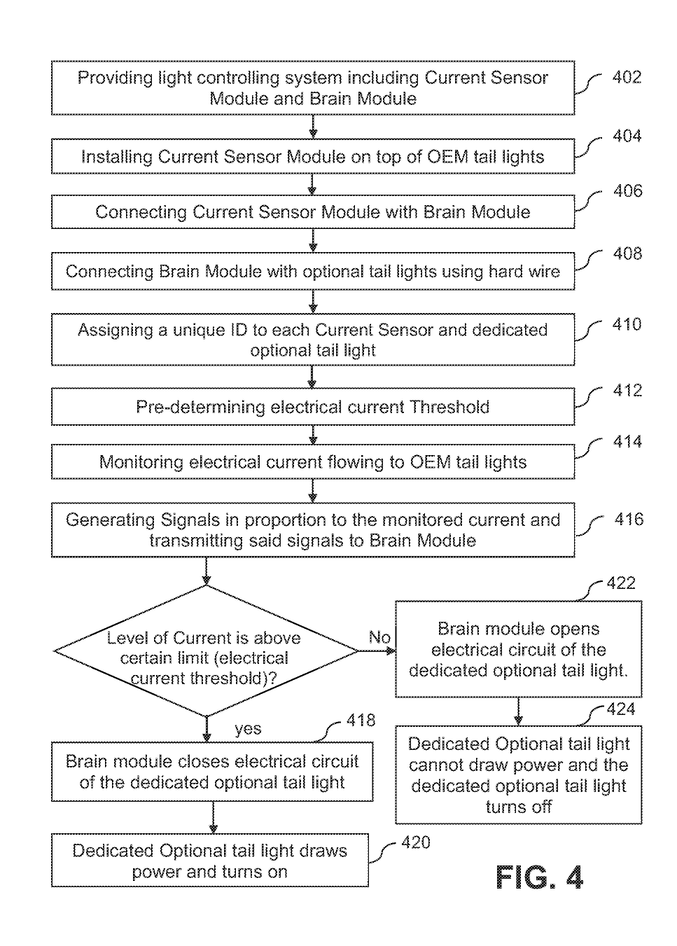

Referring to FIG. 4, there is illustrated a method 400 for controlling optional tail lights. The method commences (in step 402) with providing optional tail light controlling system of the present invention including at least one Current Sensor module and a Brain module. Next in step 404 installing current sensor module on top of OEM tail light wire including left turn wire, right turn wire, stop (brake) light wire, and running light wire, and/or wrapping the current sensor module and its dedicated wire around using any proper material. In step 406 connecting each current sensor module with brain module using hard wire or wireless communication. In step 408 connecting optional tail lights to the brain module's power source using hard wire. In step 410 Brain module starts pair-off process which assigns a unique ID to each current sensor and its dedicated optional tail light. In step 412, an electrical current threshold is predetermined and stored in Brain module. In steps 414 and 416 each current sensor constantly monitors the electrical current flowing to the OEM tail light in response to an operator's command (for example, pressing a brake pedal, turning left or right turn signal, etc.), generates signals in proportional to the monitored current and constantly sends Brain module the signals of the monitored current information of the OEM light underneath. Brain module controls opening or closing of each optional tail light's power circuit in response to the current information received from the current sensor. If the level of current detected by said current sensor reaches above a predetermined level the controller closes electrical circuit of the optional tail light equipment dedicated to that particular Sensor in step 418. The light equipment draws power and turns on in step 420. When the level of Current lowers under certain level, Brain Module opens the electrical circuit of the optional tail light equipment dedicated to a particular Sensor in step 422; the light is turned off in step 424.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. An optional tail lights control system comprising:
a plurality of current sensor module, each comprising a current sensor, a power source, and means for communicating; and
a brain module comprising means for communicating with said current sensor module, a controller, and means for supplying power to said optional tail lights equipment.

2. The optional tail lights control system of claim 1 wherein said means for communicating being a RF transmitter antenna for said current sensor module and a RF receiver antenna for said brain module.

3. The optional tail lights control system of claim 1 wherein said means for communicating being hard wire and cable for both said current sensor module and brain module.

4. The optional tail lights control system of claim 1 wherein said means for supplying power includes rechargeable battery.

5. The optional tail lights control system of claim 1 wherein said means for supplying power includes hard wire and cable for connecting to the motor vehicle on-board 12 V DC power source.

6. The optional tail lights control system of claim 1 wherein each of said current sensor assemblies is placed inside a motor vehicle on top of one of OEM tail lights wire to detect an electrical current in the wire and generate a signal proportional to said electrical current and transmits said signal to said brain module.

7. The optional tail lights control system of claim 6 wherein said controller controls pairing-off process which assigns each said current sensor module a unique ID associated with the tail light wire that said sensor is located on top of and the dedicated optional tail light equipment.

8. The optional tail lights control system of claim 7 wherein said controller controls opening and closing of each electrical circuit connecting to each of said optional tail lights equipment.

9. The optional tail lights control system of claim 8 wherein said brain module constantly receives signals from each of said current sensors, when the level of current detected by said current sensor reaches above a predetermined level said controller closes said electrical circuit of said optional tail light equipment dedicated to that particular said sensor; when the level of current lowers under certain level, said brain module opens said electrical circuit of said optional tail light equipment dedicated to that particular said sensor.

10. The optional tail lights control system of claim 1 further comprising light emitting devices or incandescent optional tail light equipment.

11. The optional tail lights control system of claim 1 wherein said controller may be one of programmable integrated circuit, microprocessor, and programmable logics controller (PLC).

12. A method of controlling optional tail lights comprising:
providing an optional tail lights controlling system including current sensor modules and brain module;
installing said current sensor modules on top of OEM tail lights wire;
connecting said current sensor modules with said brain module using wire or wireless communication;
connecting said brain module with optional tail lights in hard wire (electrical circuit);
assigning a unique ID to each current sensor and its dedicated optional tail light;
generating a pre-determined electrical current threshold;
monitoring an electrical current flowing to the OEM tail light in response to an operator's command;
generating a signal proportional to said monitored electrical current and transmitting said signal to said brain module; and
controlling said electrical circuit of said optional tail light in response to said received signal of monitored electrical current and said pre-determined current threshold.

13. The method of controlling optional tail lights of claim 12 wherein if said electrical current is above said current threshold, closing said electrical circuit of said dedicated optional tail light and if said electrical current is below said current threshold, opening said electrical circuit of said dedicated optional tail light.

14. The method of controlling optional tail lights of claim 12 further comprising providing optional tail lights equipment including LED or incandescent lights equipment.

15. The method of controlling optional tail lights of claim 12 further comprising providing a RF transmitter antenna to said Current Sensor module and a RF receiver antenna to said Brain module such that said Current Sensor module and said Brain module can communicate in wireless.

16. The method of controlling optional tail lights of claim 12 further comprising providing an independent power source to Brain module including a rechargeable battery.
